(19) United States
(12) Patent Application Publication
(10) Pub. No.: US 2025/0100127 A1
(43) Pub. Date: Mar. 27, 2025

(54) Multi-Functional Back Accessibility Device

(71) Applicant: Ted Walton, Port Alberni (CA)

(72) Inventor: Ted Walton, Port Alberni (CA)

(21) Appl. No.: 18/897,584

(22) Filed: Sep. 26, 2024

Related U.S. Application Data
(60) Provisional application No. 63/585,336, filed on Sep. 26, 2023.

(51) Int. Cl. B25J 1/02; A47G 25/90; A47K 7/02; A61H 7/00

(52) U.S. Cl. CPC B25J 1/02; A61H 7/003; A47G 25/902; A47K 7/028; A61H 2201/0161; A61H 2205/081

(57) ABSTRACT

A multi-functional back accessibility device is provided comprised of a handle with at least one grip designed for user comfort and control, potentially including a wing support feature. The handle is connected to a middle member through a fastener, allowing articulation between 0 and 359 degrees, and the middle member attaches to an end member via a similar fastener, offering flexibility during use. The fasteners, including hinges with motion-stop features, enable the device to flex for efficient backwashing. A cleaning head, which can include bristles, loofah pads, or other attachments like massage rollers, is attached to the end member. The device may also feature telescopic elements to adjust length and is designed for ease of storage and articulation.

### CROSS-REFERENCE TO RELATED APPLICATION

The present application claims priority to, and the benefit of, U.S. Provisional Application No. 63/585,336, which was filed on Sep. 26, 2023, and is incorporated herein by reference in its entirety.

### FIELD OF THE INVENTION

The present invention relates generally to the field of body care devices. More specifically, the present invention relates to a multi-functional back accessibility device comprised of a reconfigurable device that allows a user to provide basic care to different hard-to-reach body areas. Accordingly, the present disclosure makes specific reference thereto. Nonetheless, it is to be appreciated that aspects of the present invention are also equally applicable to other like applications, devices, and methods of manufacture.

### BACKGROUND

People with limited physical strength and mobility, whether due to injury, arthritis, or other medical conditions, often face significant challenges when it comes to performing basic personal care tasks that require reaching difficult areas of their bodies. The back, in particular, can be a problem area for individuals dealing with these limitations. For example, scratching an itch on the back can become a frustrating and sometimes impossible task without assistance. Similarly, applying lotion to areas on the back to soothe dry skin or maintain healthy skin may be exceedingly difficult without the help of another person. This reliance on others for such basic tasks can lead to feelings of dependence and frustration.

In addition, grooming tasks such as shaving the back pose an even greater challenge. Without the ability to see or easily reach their own back, individuals may struggle to achieve thorough and safe results without specialized tools specifically designed to extend their reach. For those with reduced mobility or strength, standard grooming tools are often ineffective, leaving them unable to manage their personal care independently. These challenges can have a significant impact on a person's confidence and overall quality of life, as they may feel that they have lost a degree of independence when it comes to their own personal grooming and hygiene.

As a result, the need for practical, easy-to-use solutions for people with these physical limitations is essential to help them maintain their dignity and autonomy. Specialized tools, ergonomic devices, and adaptive products designed to address these issues can greatly enhance the quality of life for individuals facing mobility challenges, allowing them to perform personal care tasks without relying on the help of others.

Therefore, there exists a long-felt need in the art for a device that allows a user to perform basic care tasks. There also exists a long-felt need in the art for a multi-functional back accessibility device. More specifically, there exists a long-felt need in the art for a multi-functional back accessibility device that allows a user to reach hard-to-reach areas of their body, such as but not limited to their back. In addition, there exists a long-felt need in the art for a multi-functional back accessibility device that allows a user to reach hard-to-reach areas of their body, such as but not limited to their back, and wherein the device can be used to perform basic care tasks relating to the user's back.

The subject matter disclosed and claimed herein, in one embodiment thereof, comprises a multi-functional back accessibility device. The device is comprised of a handle with at least one grip designed for user comfort and control, potentially including a wing support feature. The handle is connected to a middle member through a fastener, allowing articulation between 0 and 359 degrees, and the middle member attaches to an end member via a similar fastener, offering flexibility during use. The fasteners, including hinges with motion-stop features, enable the device to flex for efficient backwashing. A cleaning head, which can include bristles, loofah pads, or other attachments like massage rollers, is attached to the end member. The device may also feature telescopic elements to adjust length and is designed for case of storage and articulation. The knuckle mechanism at the fastener, with its spring tension and 45 to 95-degree range, provides the key functionality for attaching and operating various cleaning heads.

In this manner, the multi-functional back accessibility device of the present invention accomplishes all the forgoing objectives and provides a device that allows a user to perform basic care tasks on reach hard-to-reach areas of their body. More specifically, the device allows a user to reach hard-to-reach areas of their body, such as but not limited to their back. In addition, the device can be used to perform basic care tasks relating to the user's back.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-functional back accessibility device. The device is comprised of a handle, which may include at least one grip. The grip is designed to be ergonomic, contoured to fit the user's hand or fingers, and can be made of non-slip materials like rubber. It may also include a raised or recessed texture for additional grip and may feature a thumb-supporting wing support for enhanced stability and control. The handle can be either fixedly or removably attached to additional members, such as a middle member, through at least one connecting fastener. These fasteners allow the middle member to articulate between 0 and 359 degrees relative to the handle, enabling the handle to fold or collapse for storage.

The middle member is attached to an end member through similar fasteners, which also allow articulation between 0 and 359 degrees. This articulation enables the device to be positioned to clean all parts of a user's back comfortably. The fasteners and may be comprised of motion-stop hinges that limit movement past certain angles, such as 45 or 90 degrees, or may use torsion springs or elastic hinges. These fasteners provide flexibility, allowing the user to control the device with ease during use.

The end member is attached to a cleaning head via fasteners and, which may include various reciprocating fasteners like snap fasteners or tongue-and-groove mechanisms. The cleaning head can feature a variety of cleaning elements, including bristles or a loofah pad, depending on the specific embodiment. In some configurations, the cleaning head may also include a lotion applicator, massage roller, or even a razor, providing multifunctional use. The fasteners may allow for some degree of swivel, enhancing the range of motion for cleaning or other tasks.

In one embodiment, the handle, middle member, and end member are each of a fixed length, though they may also be telescopic to allow for adjustable length. To secure these components at a desired length, various locking mechanisms such as spring-tab or button locks may be used. The method of using the device involves positioning the middle and end members relative to the handle via the articulated fasteners and attaching the cleaning head before use.

Accordingly, the multi-functional back accessibility device of the present invention is particularly advantageous as it provides a device that allows a user to perform basic care tasks on reach hard-to-reach areas of their body. More specifically, the device allows a user to reach hard-to-reach areas of their body, such as but not limited to their back. In addition, the device can be used to perform basic care tasks relating to the user's back. In this manner, the multi-functional back accessibility device provides a solution to accessing and performing basic care tasks on hard-to-reach areas of the body.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multi-functional back accessibility device of the present invention while partially folded in accordance with the disclosed architecture;

FIG. 2 illustrates a perspective front view of one potential embodiment of a cleaning head of a multi-functional back accessibility device of the present invention in accordance with the disclosed architecture;

FIG. 3 illustrates a perspective front view of one potential embodiment of a cleaning head of a multi-functional back accessibility device of the present invention in accordance with the disclosed architecture;

FIG. 4 illustrates a perspective front view of one potential embodiment of a cleaning head of a multi-functional back accessibility device of the present invention in accordance with the disclosed architecture;

FIG. 5 illustrates a perspective front view and side view of one potential embodiment of a cleaning head of a multi-functional back accessibility device of the present invention in accordance with the disclosed architecture;

FIG. 6 illustrates a perspective front view of one potential embodiment of a cleaning head of a multi-functional back accessibility device of the present invention in accordance with the disclosed architecture;

FIG. 7 illustrates a perspective side view of one potential embodiment of a cleaning head of a multi-functional back accessibility device of the present invention in accordance with the disclosed architecture; and

FIG. 8 illustrates a flowchart of a method of using one potential embodiment of a multi-functional back accessibility device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to perform basic care tasks. There also exists a long-felt need in the art for a multi-functional back accessibility device. More specifically, there exists a long-felt need in the art for a multi-functional back accessibility device that allows a user to reach hard-to-reach areas of their body, such as but not limited to their back. In addition, there exists a long-felt need in the art for a multi-functional back accessibility device that allows a user to reach hard-to-reach areas of their body, such as but not limited to their back, and wherein the device can be used to perform basic care tasks relating to the user's back.

The present invention, in one exemplary embodiment, is comprised of a multi-functional back accessibility device. The device is comprised of a handle that may incorporate at least one grip. The grip is ergonomically designed, contoured to fit the user's hand or fingers, and can be made from non-slip materials like rubber. It may also feature raised or recessed textures for improved grip, and can include a thumb-supporting wing for added stability and control. The handle can be either permanently or removably connected to additional components, such as a middle member, using at least one connecting fastener. These fasteners allow the middle member to rotate between 0 and 359 degrees relative to the handle, enabling it to fold or collapse for storage.

The middle member connects to an end member via similar fasteners, allowing it to rotate between 0 and 359 degrees as well. This articulation makes it possible for the device to comfortably clean various parts of the user's back. The fasteners may include motion-stop hinges that limit movement at certain angles, like 45 or 90 degrees, or may utilize torsion springs or elastic hinges. These fasteners provide flexibility, making the device easy to control during use.

The end member attaches to a cleaning head using fasteners, which may include various interlocking mechanisms, such as snap fasteners or tongue-and-groove systems. The cleaning head can accommodate different cleaning elements, such as bristles or a loofah pad, depending on the design. In some versions, the cleaning head may also feature a lotion applicator, massage roller, or even a razor, offering multifunctional use. The fasteners may also allow for swiveling, increasing the range of motion for cleaning or other tasks.

In one configuration, the handle, middle member, and end member are fixed in length, though they can also be telescopic for adjustability. Various locking mechanisms, such as spring-tabs or button locks, can be used to secure the components at a desired length. The method of using the device involves adjusting the middle and end members relative to the handle via the articulated fasteners and attaching the cleaning head before use.

Thus, the multi-functional back accessibility device is especially advantageous because it allows the user to access hard-to-reach areas of their body, particularly the back, to perform basic care tasks. This device offers a practical solution for reaching and maintaining areas of the body that are otherwise difficult to reach.

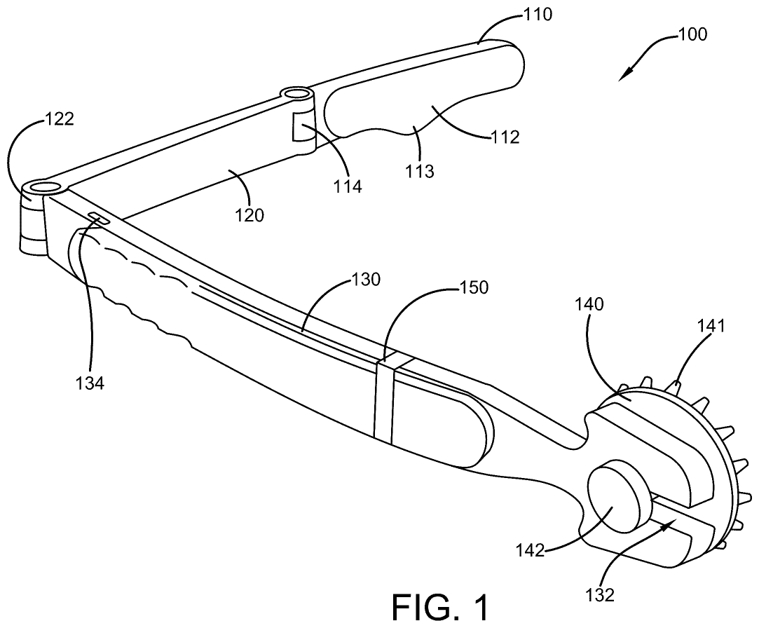

Referring initially to the drawings, FIG. 1 illustrates a perspective view of one potential embodiment of a multi-functional back accessibility device 100 of the present invention while partially folded in accordance with the disclosed architecture. The device 100 is comprised of handle 110. The handle 110 may be comprised of at least one grip 112. In one embodiment, the grip 112 is contoured to receive the hand(s) and/or fingers of a user. The grip 112 may be any size, shape, and grip configuration. The grip 112 may be made from a non-slip material, such as but not limited to rubber. For further grip, the grip 112 may have a raised or recessed texture. The grip 112 may be comprised of a wing support feature 113 that functions as a thumb support for stability and control.

The handle 110 may be fixedly or removably attached to at least one additional member, such as but not limited to a middle member 120. More specifically, the middle member 120 attaches to the handle 110 via at least one connecting fastener 114 such as but not limited to a hinge, a locking hinge, etc. that allows the middle member 120 to articulate between 0 and 359 degrees relative to the handle 110. The handle can fold/collapse against the middle member 120 when stored. The fastener 114 may be comprised of a combination of fasteners such as but not limited to a hinge and a buckle.

The middle member 120 then attaches to at least one end member 130 via at least one connecting fastener 122 such as but not limited to a hinge, a locking hinge, etc. that allows the end member 130 to articulate between 0 and 359 degrees relative to the middle member 120. As a result of the articulation of both members 120,130, the device 100 can achieve the necessary positioning to wash all parts of a user's back.

The fasteners 114,122 allow the device to flex during use such that a user can comfortably control the position of the device 100 with their arm and wrist. Either or both fasteners 114,122 may be comprised of a motion-stop hinge that prevents the fasteners 114,122 from extending past a certain degree. The fasteners 114, 122 may be comprised of a torsion spring hinge (wherein the fasteners 114,122 pivots against spring force) or an elastic hinge or an elastic band. The fasteners 114,122 may be comprised of a hinge with a plurality of pre-determined range of motion stops, preferably at 45 and 90 degrees.

The end member 130 is comprised of at least one fastener 132 that receives at least one fastener 142 of at least one cleaning head 140. In this manner, the cleaning head 140 attaches to the end member 130. The fasteners 132,142 may be any type of reciprocating fastener type such as but not limited to male and female, tongue and groove, snap fasteners, etc. In the preferred embodiment, the fastener 132 of the end member 130 is a slot that receives the fastener 142 of the head 140, wherein said fastener 142 is a male tab. The end member 130 may removably attach to the middle member 120 (and/or be detached from itself into two pieces) via at least one fastener 134 such as but not limited to a button fastener.

The head 140 is may be comprised of at least one bristle 141. The bristle 141 may be any configuration of natural or synthetic bristle (or other scrubbing element/structure).

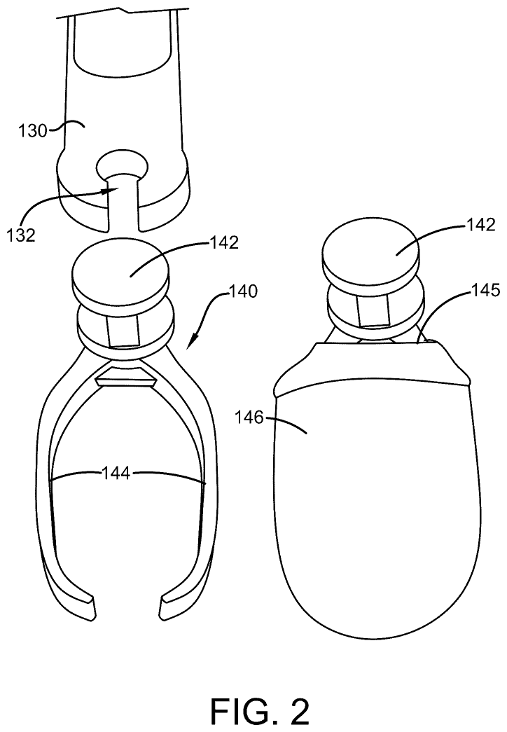

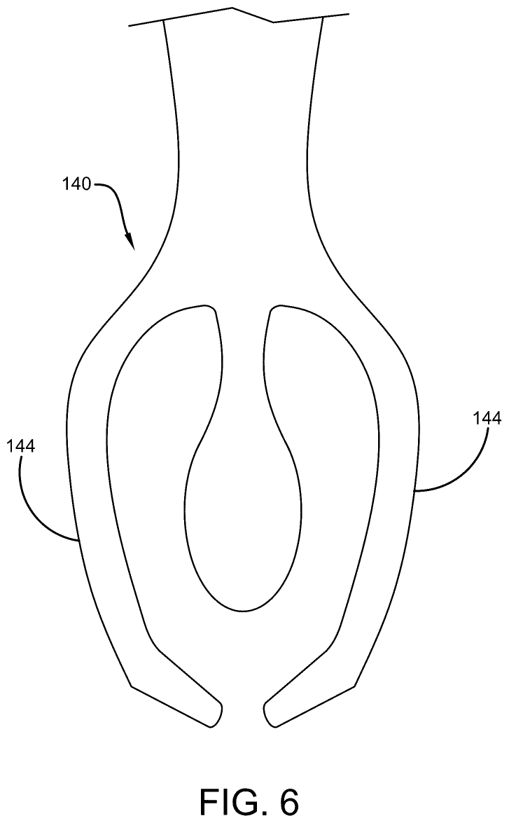

In a different embodiment, the head 140 is comprised of at least one (but preferably two) arm(s) 144 that removably receive at least one loofah pad 146 via placing the arms 144 inside an opening 145 of the pad 146, as seen in FIG. 2. An embodiment with arms 144 may also be seen in FIG. 6. In a different embodiment, the loofah pad 146 is fixedly attached to the arms 144. The arms 144 may be flexible in one embodiment.

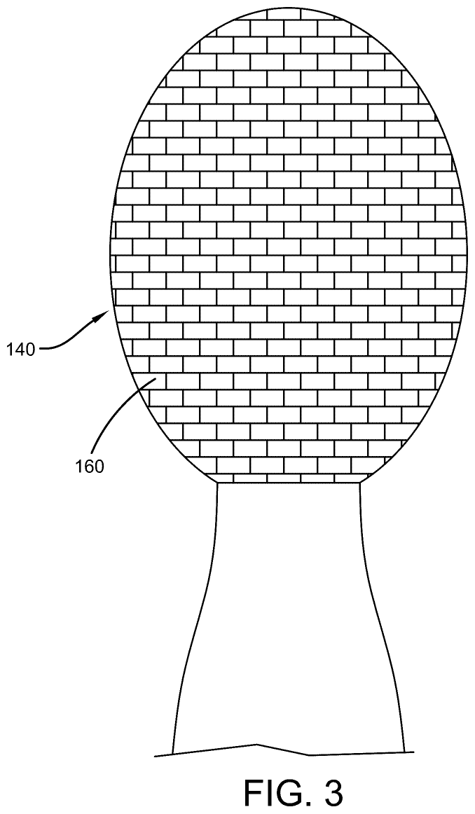

In one embodiment, the head 140 is comprised of at least one lotion applicator 160 comprised of a raised, rectangular ribbed pattern, as seen in FIG. 3.

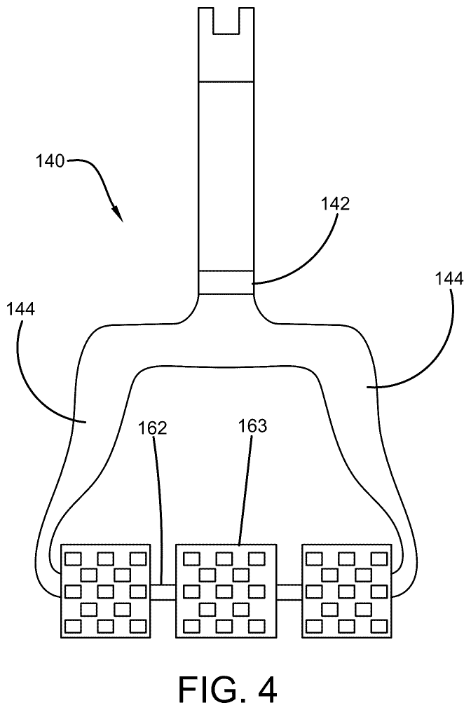

In one embodiment, at least one massage roller 161 is positioned between the arms 144, as seen in FIG. 4. The roller 161 is comprised of a central axle 162 wherein at least one massage roller 163 can rotate 360 degrees around relative to a horizontal axis of the axle 162. In this embodiment, the fasteners 132,142 may be comprised of swivel fasteners that preferably allow 35 degrees of swivel.

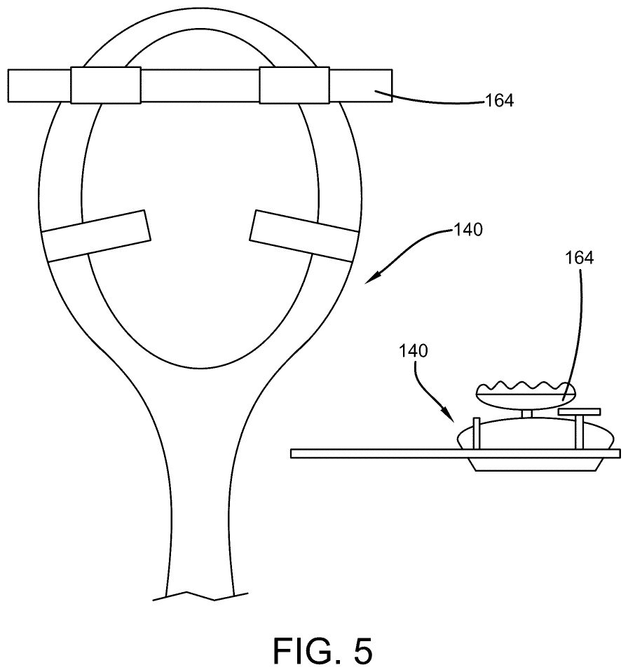

In one embodiment, at least razor 164 is positioned between the arms 144, as seen in FIG. 5. The razor 164 may be a bladed razor or an electric razor of any style and configuration.

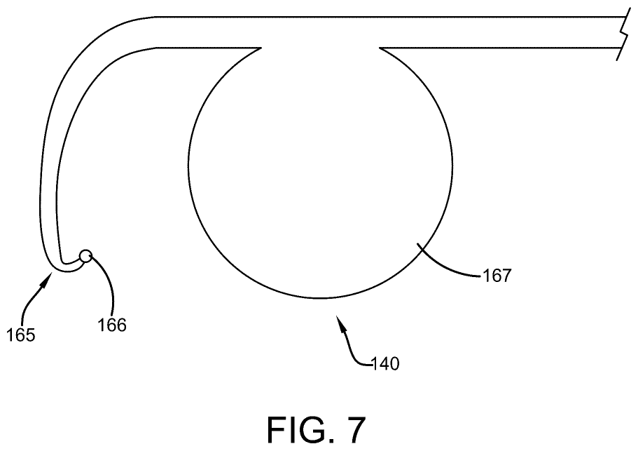

In one embodiment, the head 140 is comprised of a zipper-pulling structure 165 with a balled tip 166 and secondary ball 167, as seen in FIG. 7.

In one embodiment, the handle 110, middle member 120, and end member 130 are each of a fixed length. In another embodiment, any of the handle 110 or members 120,130 may be telescopic such that the length of the same can be adjusted as needed. To secure the handle 110 and/or members 120,130 at a desired length, each of the same may be comprised of at least one locking member 150 such as but not limited to a spring-tab button lock, a button lock, a clamp lock, a rotating lock, etc.

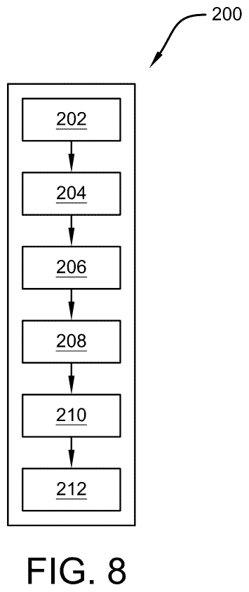

The present invention is also comprised of a method of using 200 the device 100, as seen in FIG. 8. First, a device 100 is provided comprised of a handle 110, a middle member 120 attached to the handle 110 via at least one connecting fastener 114, an end member 130 attached to the middle member 120 via at least one connecting fastener 114, and a cleaning head 140 (that may also be comprised of a loofah pad 146) [Step 202]. Then, the middle member 120 can be articulated about the connecting fastener 114 until it is in a desired position relative to the handle 110 [Step 204]. Then, the end member 130 can be articulated about the connecting fastener 122 until it is in a desired position relative to the middle member 120 [Step 206]. Next, at least one cleaning head 140 can be attached to the end member 130 [Step 208]. In an alternative embodiment, at least one loofah pad 146 can be attached to the cleaning head [Step 210]. Finally, the cleaning head 140 can be used to scrub/clean a user's back area while the user grips the handle 110 [Step 212].

In between 122 and 130 you can see where it can be detached for the roller or other attachments. 122 is called the knuckle and is just about the whole entirety of the invention. The spring or elastic stops closing at 45 degrees and opens to 95 degrees under constant resistance between positions

It would be important to make sure we are specific enough about the Knuckle and where it detaches between 122 and 130. 114 only opens or closes for travel or storage and fully opens and stays open while in use. 122 is the 45-degree to 95 degrees spring tension. It releases in between 122 and the rubber finger grips you will see a button with no number designated to it. The reacher and the knuckle with the spring tension with 45 to 95-degree range and the way it attaches to the attachments up by the knuckle is the actual invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-functional back accessibility device” and “device” are interchangeable and refer to the multi-functional back accessibility device 100 of the present invention.

Notwithstanding the forgoing, the multi-functional back accessibility device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multi-functional back accessibility device 100 as shown in the FIGS. are for illustrative purposes only, and that many other sizes and shapes of the multi-functional back accessibility device 100 are well within the scope of the present disclosure. Although the dimensions of the multi-functional back accessibility device 100 are important design parameters for user convenience, the multi-functional back accessibility device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-functional back accessibility device comprising:
a handle;
a middle member, wherein the middle member is attached to the handle via a first connecting fastener, the first connecting fastener allowing articulation of the middle member relative to the handle between 0 and 359 degrees;
an end member, wherein the end member is attached to the middle member via a second connecting fastener, the second connecting fastener allowing articulation of the end member relative to the middle member between 0 and 359 degrees; and
a cleaning head removably attached to the end member.

2. The multi-functional back accessibility device of claim 1, wherein the handle is comprised of a grip.

3. The multi-functional back accessibility device of claim 1, wherein the first connecting fastener and the second connecting fastener are comprised of a hinge.

4. The multi-functional back accessibility device of claim 3, wherein the hinge is comprised of a motion-stop hinge.

5. The multi-functional back accessibility device of claim 1, wherein the cleaning head is comprised of a bristle.

6. The multi-functional back accessibility device of claim 1, wherein the handle is comprised of a telescopic handle.

7. The multi-functional back accessibility device of claim 1, wherein the cleaning head is comprised of a massage roller.

8. The multi-functional back accessibility device of claim 1, wherein the middle member is comprised of a telescopic middle member.

9. A multi-functional back accessibility device comprising:
a handle comprised of a contoured grip;
a middle member attached to the handle via a first hinge;
an end member attached to the middle member via a second hinge; and
a cleaning head attached to the end member via a fastener.

10. The multi-functional back accessibility device of claim 9, wherein the contoured grip is comprised of a non-slip material.

11. The multi-functional back accessibility device of claim 9, wherein the contoured grip is comprised of a wing support.

12. The multi-functional back accessibility device of claim 9, wherein the contoured grip is comprised of a texture.

13. The multi-functional back accessibility device of claim 9, wherein the first spring is comprised of a torsion spring hinge.

14. The multi-functional back accessibility device of claim 9, wherein the second spring is comprised of a torsion spring hinge.

15. The multi-functional back accessibility device of claim 9, wherein the cleaning head is comprised of a lotion applicator comprised of a raised, ribbed pattern.

16. A multi-functional back accessibility device comprising:
a handle comprised of a contoured grip;
a middle member attached to the handle via a first hinge;
an end member attached to the middle member via a second hinge; and
a cleaning head attached to the end member via a fastener, the cleaning head comprised of a pair of arms.

17. The multi-functional back accessibility device of claim 16, wherein the cleaning head is comprised of a massage roller.

18. The multi-functional back accessibility device of claim 16, wherein the cleaning head is comprised of a razor.

19. The multi-functional back accessibility device of claim 16, wherein the cleaning head is comprised of a loofah pad.

20. The multi-functional back accessibility device of claim 16, wherein the cleaning head is comprised of a zipper-pulling structure.
